(19) United States
(12) Patent Application Publication
(10) Pub. No.: US 2025/0154364 A1
(43) Pub. Date: May 15, 2025

(54) COATING AGENT

(71) Applicant: SGL CARBON SE, Wiesbaden (DE)

(72) Inventors: Thomas KOECK, Meitingen (DE); Christina LOEFFLAD, Meitingen (DE)

(21) Appl. No.: 17/928,499

(22) PCT Filed: May 27, 2021
(86) PCT No.: PCT/EP2021/064153

§ 371 Date: Nov. 29, 2022

(30) Foreign Application Priority Data
May 29, 2020 (DE) 10 2020 206 776.7

(51) Int. Cl. C09D 5/24; C08K 7/24; C09D 5/08; C09D 7/20; C09D 7/40; C09D 7/45; C09D 7/61; C09D 7/80; C09D 183/06

(52) U.S. Cl. CPC C09D 5/24; C08K 7/24; C09D 5/084; C09D 7/20; C09D 7/45; C09D 7/61; C09D 7/69; C09D 7/70; C09D 7/80; C09D 183/06; C08K 2201/001; C08K 2201/005

(57) ABSTRACT

A coating agent for forming an electrically conductive coating on a substrate, the coating agent including expanded graphite and a binder, and the ratio Q_{B} of the mass of the expanded graphite contained in the coating agent to the residual dry mass of the coating agent being at least 0.25.

### FIELD

The present invention relates to a coating agent for forming an electrically conductive coating on a substrate, to coatings, to composite coatings, to the use of the coating agent for protection against corrosion, and to a method and a premix for producing the coating agent.

### BACKGROUND

In connection with the production of capacitive sensors for soft systems, it has already been proposed to disperse expanded graphite in liquid media (White et al., Adv. Mater Technol. 2017, 2, 1700072). Soft systems are systems that can be stretched by more than 100%, such as elastomers. Such strains could not be captured, or could only be captured with difficulty, by conventional strain gauges. White et al. therefore indicate the need to provide highly deformable, electrically conductive materials whose moduli resemble those of non-traditional soft materials such as elastomers or biological tissues. Composite sensors are proposed whose electrical conductivity is provided by expanded intercalated graphite (EIG). Their manufacture involves ultrasonic treatment of EIG (obtained by means of intercalated sulphuric acid) in cyclohexane, mixing the EIG in cyclohexane with a specific silicone elastomer, and then casting conductive composite films such that a graphite content of 10 wt. % is obtained in the final composite. In certain tests, the proportion of graphite was increased to up to 20 wt. %, with no further increase in electrical conductivity being able to be achieved above 15%.

The present invention addresses other problems. The invention should be considered to be in the field of fuel cell technology and redox flow battery technology.

Fuel cells (FCs) and redox flow batteries (RFBs) contain bipolar plates, which can be metal-based or graphite-based, for example. Their function is well known to those skilled in the field of fuel cell and redox flow battery technology, which is why their function will not be discussed further here. Bipolar plates can be very thin. Therefore, in connection with the present invention, reference is not made to bipolar plates, but to bipolar flat elements.

Redox reactions take place in FCs and RFBs, and can lead to corrosion of metallic bipolar flat elements. Mechanical damage occurs in graphite-based bipolar flat elements, with graphite particles being detached from the plate by the surrounding media. There is a desire to counteract these corrosion and disintegration problems in order to increase the service life of FCs, RFBs, or at least of the bipolar flat elements contained therein. In principle, it is conceivable to seal the bipolar flat elements by applying a coating. However, many coatings that are produced with conventional coating agents, such as polymer-based coating agents, have an electrical resistance that is far too high. Polymer-based coating agents frequently form almost completely insulating coatings. The application of such coatings to the surface of bipolar flat elements is not an option, since they can then no longer be used for their intended purpose.

Bipolar flat elements can have flow fields. A flow field is a channel structure formed on the surface of the bipolar plate that promotes an even distribution of reactants over the entire surface. Such flow fields can be formed by deformation moulding, for example by press-fitting the flow field. It is conceivable to apply a coating that protects against corrosion and disintegration before the deformation (pre-coating), or after the deformation (post-coating). The problem with a pre-coating is that the coating has to be deformed as well. There must be no cracks in the coating. With post-coating, it is difficult to apply an even, sealed coating to the deformed, for example wavy, surface.

Briefly summarised, the following difficulties exist:
to produce a bipolar flat element in a simple manner;
at the same time, to produce it in such a way that it can be tailored to the requirements in specific FC or RFB systems, for example by forming flow field channel structures of almost any shape;
in the process, also to ensure a sufficiently low area-specific volume resistivity on the surface of the bipolar flat element that a high level of efficiency, i.e. energetically efficient operation of the FC or RFB, is possible; and
to protect the bipolar flat element from corrosion and disintegration in such a way that energetically efficient operation can be maintained over the long term.

### SUMMARY

The present invention addresses the problem of overcoming these difficulties by providing a coating agent for bipolar flat element surfaces.

The object of the present invention is therefore to be seen as providing a coating agent for bipolar flat element surfaces with which a bipolar flat element for an FC or RFB can be produced particularly easily and tailored to the respective FC or RFB. At the same time, energetically efficient operation of the FC or RFB should be able to be permanently maintained with the bipolar plate.

This object is achieved by a coating agent for forming an electrically conductive coating on a substrate, wherein the coating agent contains expanded graphite and a binder, and the ratio Q_{B} of the mass of the expanded graphite contained in the coating agent to the residual dry mass of the coating agent is at least 0.25.

The ratio Q_{B} can therefore be calculated using the following equation:

$${Q}_{B} = \frac{{m}_{BG}}{{m}_{BR}}$$

where
m_{BG} stands for the mass of the expanded graphite contained in the coating agent, and
m_{BR} stands for the residual dry mass of the coating agent.

The ratio Q_{B} is at least 0.25. There is no upper limit to Q_{B}, since particularly with relatively thick coatings, coatings which seal and which protect against corrosion can be produced even with very high proportions of expanded graphite. Q_{B} is preferably at most 0.97. Q_{B} can in particular be in the range from 0.25 to 0.94, preferably in the range from 0.30 to 0.90, particularly preferably in the range from 0.30 to 0.80.

The coating agent is suitable for forming an electrically conductive coating. The specification “electrically conductive” relates to the electrical conductivity through the coating. This is because, with a bipolar flat element, it is important that there is electrical conductivity through the coating. This is discussed in more detail below in connection with coatings and composite coatings according to the invention.

### BRIEF DESCRIPTION OF THE DRAWINGS

The invention is illustrated by the following examples and figures, without being restricted thereto.

FIGS. 1 and 2 show particle size distributions of expanded graphite present in the form of particles.

### DETAILED DESCRIPTION

The coating agent contains expanded graphite. Expanded graphite is also referred to as exfoliated graphite or expandable graphite. The production of expanded graphite is described, for example, in U.S. Pat. Nos. 1,137,373 and 1,191,383. It is known that expanded graphite can be produced, for example, by treating graphite with certain acids, thereby forming a graphite salt with acid anions intercalated between layers of graphene. The graphite salt is then expanded by exposing it to high temperatures of from, for example, 800° C. For example, to produce expanded graphite having a vermiform structure, graphite such as natural graphite is usually mixed with an intercalate such as nitric acid or sulphuric acid and heat-treated at an elevated temperature of from, for example, 600° C. to 1200° C. (see DE10003927A1).

The expanded graphite contained in the coating agent is typically a partially mechanically exfoliated expanded graphite. “Partially mechanically exfoliated” means that the expanded vermiform structure is in a partially sheared form; partial shearing occurs, for example, by ultrasonic treatment of the vermiform structure. Only partial exfoliation occurs during the ultrasonic treatment, so that average particle sizes d50 occur in the micrometre range. In this case, there is no cleavage into individual graphene layers. However, it is possible to comminute the expanded vermiform structure in other ways. The expanded graphite contained in the coating agent should therefore not be limited to expanded graphite that has been partially mechanically exfoliated. The expanded graphite can be described in more detail, for example, via its average particle size, regardless of the way in which the average particle size can be manipulated.

According to the invention, the expanded graphite contained in the coating agent (for example, the partially mechanically exfoliated expanded graphite) is preferably in the form of particles whose average particle size d50 is less than 50 μm, generally less than 30 μm, preferably less than 25 μm, particularly preferably less than 20 μm—for example, less than 15 μm. The average particle size d50 is determined as described herein. Small particle sizes favour a high density of the coating that can be formed with the coating agent. If the average particle size d50 is small compared to the coating thickness, no (or virtually no) particle extends over the entire coating thickness. This increases both the corrosion resistance of a bipolar flat element coated with the coating agent and the mechanical strength of the coating. As a result, a high degree of freedom of design for flow fields, and at the same time a particularly high stability of the FC or RFB, is achieved. The desired particle size distribution can be set by ultrasound treatment, for example as shown below by way of example.

The mean particle sizes d50 given here are based on volume. The underlying particle size distributions (volume-based distribution sum Q₃ and distribution density q₃) are determined by laser diffraction according to ISO 13320-2009. A measuring device from Sympatec with a SUCELL dispersing unit and HELOS (H2295) sensor unit can be used for this purpose.

Certain coating agents according to the invention contain no particles whose diameter is more than 100 μm. It is particularly preferred if no particles are present whose diameter is more than 50 μm. This is effected by a person skilled in the art by forcing the coating agent through a grid with a mesh size of 100 μm or with a mesh size of 50 μm. If necessary, the coating agent is diluted beforehand so that it can easily pass through the grid. The (optionally diluted) coating agent on the grid is carefully stirred in order to break up agglomerates of smaller particles. If the coating agent complies with this upper particle size limit, it is stable and can be used in a variety of ways, without the narrow pores of, for example, sieves, nozzles, etc.—which certain coating devices, in particular coating devices for spraying on the coating agent, may have—clogging during processing.

The coating agent according to the invention advantageously has a surface resistance of from 5.0*10⁻⁶ Ωcm² to 9.0*10⁻³ Ωcm², preferably 8.0*10⁻⁵ Ωcm² to 1.0*10⁻³ Ωcm², particularly preferably 1.5*10⁻⁵ Ωcm² to 7.0*10⁻⁵ Ωcm². With a surface resistance of less than 5.0*10⁻⁶ Ωcm², the amount of binder is no longer sufficient to achieve a sufficiently strong bond to the substrate. With a surface resistance of more than 9.0*10⁻³ Ωcm², the electrical conductivity for the application, for example for printable electronics or bipolar plates, is no longer sufficient.

The coating agent according to the invention has the advantage that, despite the binder, it can be recompacted by a factor of about 10, and the electrical properties of the coating are thus significantly improved. This is due to the expanded graphite made from natural graphite, because the expanded graphite made from natural graphite is more strongly aligned as a result of the post-compacting, and the surface resistance decreases and the electrical conductivity increases, particularly in the plane. This is particularly advantageous for use as an electrically conductive ink.

The coating agent contains a binder. Any binder is suitable which allows the coating to be formed on a substrate, for example on the bipolar flat element, in such a way that the bipolar flat element is attacked more slowly by the surrounding corrosive medium than without the coating.

The binder can comprise, for example, thermoplastics and/or thermosets. Thermoplastics are easy to process. They are thermoformable. Coating agents that comprise a thermoplastic can be shaped, for example, by hot calendering. If the coating agent contains a thermoset as a binder, this allows the production of particularly heat-resistant coatings. Bipolar flat elements having such coatings can be used, for example, in high-temperature PEM fuel cells, for example at a typical operating temperature of 180° C.

For example, the binder can comprise polypropylenes, polyethylenes, polyphenylene sulphides, fluoropolymers, phenolic resins, furan resins, epoxy resins, polyurethane resins, and/or polyester resins.

Fluoropolymers are preferred because of their particularly high corrosion resistance. Suitable fluoropolymers include polyvinylidene fluoride-hexafluoropropylene copolymers, polyvinylidene fluoride, ethylene-tetrafluoroethylene copolymers, tetrafluoroethylene-hexafluoropropylene copolymers, and polytetrafluoroethylenes. Polyvinylidene fluoride-hexafluoropropylene copolymers have proven to be particularly suitable fluoropolymers.

The binder may comprise a silicon compound comprising a moiety R, wherein
R stands for —Si(OR¹)(OR²)(OR³), —O—Si(OR¹)(OR²)(R³), or —O—Si(OR¹)(OR²)(OR³), and wherein
R¹, R² and R³ are moieties each bonded via a carbon atom.

R¹, R² and R³ preferably stands für hydrocarbyl, alkoxyhydrocarbyl or polyalkoxyhydrocarbyl, particularly preferably for alkyl, alkoxyalkyl or polyalkoxyhydrocarbyl, most preferably for C₁-C₁₈-alkyl, for example methyl, ethyl, propyl, propyl, butyl, hexyl, of which methyl is particularly preferred.

The silicon compound can be a polymeric silicon compound. As such, the silicon compound can comprise a polymer chain which has a plurality of moieties R.

However, the silicon compound preferably includes a polymerisable group. Any polymerisable moiety can be used. The polymerisable moiety can be selected from epoxy, alkenyl, lactamyl, with epoxy being particularly preferred. Polymerisation then results in the silicon compound comprising polymer chains having multiple moieties R.

The polymerisable moiety can bond to the moiety R via a linker. The linker can be of such length that the silicon atom of the moiety R is bonded to the polymerisable group by 3 to 15 consecutive atoms.

A particularly preferred silicon compound is [3-(2,3-epoxypropoxy)propyl]trimethoxysilane, shown below:

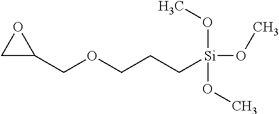

where R stands for —Si(OCH₃)₃ and the polymerisable moiety is epoxy. The linker (in this case: —CH₂—O—CH₂—CH₂—CH₂—) is long enough so that the silicon atom of the moiety R is attached to the epoxy moiety via 5 consecutive atoms.

It goes without saying that the information given here on the binder contained in the coating agent also applies to the binders of the coatings and composite coatings according to the invention described herein.

If the ratio Q_{B} does not result from the formulation according to which a coating agent according to the invention was produced, Q_{B} can be determined as follows:

Two samples of equal weight of a coating agent are taken.

All volatile components are removed from the first sample by evaporation. The temperature is kept as low as possible so that the contained binder does not begin to decompose. In particular, if relatively high-boiling but volatile diluents such as N,N-dimethylformamide (DMF) or N-methyl-2-pyrrolidone (NMP) are present in the coating agent, evaporation takes place under reduced pressure, for example, under fine vacuum. The complete evaporation of certain residual diluents can be accelerated by adding solvents (for example, n-heptane or ethylbenzene in the case of DMF) with which the particular diluent forms an azeotrope. The residual dry mass of the first sample is then determined by weighing. If it contains volatile binder components, the procedure for the first sample is as described, but the binder is cured beforehand or during evaporation. The residual dry mass m_{BR} is therefore the mass of the non-volatile coating agent components contained in the coating agent, which includes the binder and expanded graphite. Like the residual dry matter, the mass of the non-volatile coating components contained in the coating is also determined, with the coating initially being detached. The detachment can be mechanical or, for example, be done with a volatile solvent.

The expanded graphite is separated from the second sample by filtration; the expanded graphite filter cake is washed with solvent in order to free it from residual binder components, the expanded graphite thus obtained is dried, and its mass is determined m_{BG} by weighing.

Q_{B} is then calculated by dividing the mass of the expanded graphite m_{BG} separated from the second sample by the residual dry matter m_{BR} determined from the first sample.

Coating agents according to the invention generally contain a diluent. Typically, at least a portion of the expanded graphite is dispersed in the diluent and at least a portion of the binder is dispersed or dissolved in the diluent. The effect of this is that a particularly homogeneous coating agent can be provided, which results in a particularly uniform distribution of graphite and binder in the coating that can be produced with the coating agent. Ultimately, this leads to a particularly reliable sealing of the substrate or the bipolar flat element and to a longer service life of the FC and RFB. Further advantages consist in the fact that the viscosity can be adjusted to any degree by carefully selecting the proportion of diluent. The diluent can comprise water or organic solvents. Preferred organic solvents are polar aprotic solvents and aromatic solvents. Suitable polar aprotic solvents comprise ketones, N-alkylated organic amides, or N-alkylated organic ureas; with ketones or N-alkylated cyclic organic amides or N-alkylated cyclic organic ureas being preferred—for example acetone, NMP and DMF. Suitable aromatic solvents comprise alkyl benzenes, especially mono- or di-alkyl benzenes, preferably toluene or xylenes, for example toluene. Among the solvents mentioned, preference is given to those whose boiling point at 1013.25 mbar is below 250° C., in particular below 230° C., for example below 210° C. This promotes the drying process after the coating agent has been applied to the substrate or to the bipolar flat element. When choosing the diluent and binder, a person skilled in the art can ensure that as much of the binder as possible dissolves in the diluent, so that a relatively low-viscosity coating agent with high mass fractions of expanded graphite and binder can be obtained. The coating can then be carried out more easily, since less solvent is released during drying or curing.

The coating agent can contain 1 to 35 wt. %, preferably 2 to 25 wt. %, particularly preferably 2.5 to 20 wt. %, of expanded graphite. It was found that stable coating agents could be formulated within these limits, which at the same time could be applied very well to substrate surfaces. The coatings obtained in this way also had low electrical resistances, so that bipolar flat elements could be realised with very low area-specific volume resistances.

The invention also relates to coatings obtainable with the coating agent.

One subject of the invention is a coating containing expanded graphite and a binder, wherein the regions comprising the expanded graphite have an average length, parallel to the surfaces of the coating, which is at least twice, in particular at least four times, preferably at least six times, for example at least eight times, as large as their average thickness. If the coating has a flow field, this average length versus average thickness relationship holds at least in a particularly thin region of the coating. The average thickness is measured orthogonally to the surfaces of the coating. Once the coating agent is applied to the substrate, its thickness can be greatly reduced by compression. This can take place over the entire surface, or also only locally. For example, starting from a 200 μm-thick applied coating agent, a flow field with 100 μm-deep channels can be generated with an embossing tool. This results in strong compression of the regions comprising the expanded graphite, particularly in the region of the channels. The compression is substantially only orthogonal to the surfaces of the coating.

To determine the average length and thickness, a coating (and the substrate or bipolar flat element on which the coating is applied) is cut, and then an average length and an average thickness of the regions comprising the expanded graphite are determined microscopically in the cut surface. The cut surface can be formed by means of a wire saw and subsequent polishing. A focused ion beam (FIB) can also be used, in order not to destroy or falsify the coating structure during the preparation. The cut surface of the coating is then analysed microscopically.

One subject of the invention is a coating containing expanded graphite and a binder, wherein the ratio Qₛ, calculated according to the following equation:

$${Q}_{S} = \frac{{m}_{SG}}{{m}_{SR}}$$

where
m_{SG} stands for the mass of the expanded graphite contained in the coating, and
m_{SR} stands for the mass of the non-volatile coating components contained in the coating,
   is at least 0.25. There is no upper limit to Qₛ, since it is precisely the case that, with relatively thick coatings, it is possible to produce coatings that seal and that protect against corrosion, even with very high proportions of expanded graphite. Qₛ is preferably at most 0.97. Qₛ can in particular be in the range from 0.25 to 0.94, preferably in the range from 0.30 to 0.90, particularly preferably in the range from 0.30 to 0.80.

Of course, the present invention also includes a coating in which the regions comprising the expanded graphite have a ratio of average length to average thickness as described herein, and the ratio Qₛ is as also described herein.

A further subject of the invention is a composite coating comprising a coating containing expanded graphite and a binder (for example, a coating according to the invention described herein) on an electrically conductive substrate. This allows electrical current to flow through the coating into the substrate. At the same time, the coating prevents the substrate from coming into direct contact with surrounding corrosive fluids. Substrates that are susceptible to corrosion or disintegration coated in this way can also be used in corrosive liquids if current must flow from the liquid into the substrate, or vice versa. The electrically conductive substrate may have a flat metal element or a flat graphite element. The flat metal element can be a metal plate or metal foil. A flat graphite element comprises a flat material formed by compression of expanded graphite particles.

The composite coating can be a bipolar flat element for an FC or an RFB.

The area-specific volume resistance of the composite coating or of the bipolar flat element can be, for example, at most 20 mΩ·cm², preferably at most 10 mΩ·cm².

Coating agents, coatings, and composite coatings (for example, bipolar flat elements) according to the invention generally contain a dispersing agent. Depending on the diluent, different dispersing agents can be used which bring about steric stabilisation, static stabilisation, or electrosteric stabilisation of the coating agent. For the selection of suitable dispersing agents, a person skilled in the art will refer to the relevant specialist literature (see, for example, Artur Goldschmidt, Hans-Joachim Streitberger: BASF—Handbuch Lackiertechnik. Vincentz, Hanover 2002, ISBN 3-87870-324-4). The dispersing agent can be a cationic, anionic (for example, alcohol ethoxy sulphates [AES]), a zwitterionic surfactant, or a polymeric dispersing agent. Suitable polymeric dispersing agents are, for example, polyalkoxylated compounds (for example, Tween20 or Tween80) or polyvinylpyrrolidone (PVP). Suitable dispersing agents are also Byk-190 and Byk-2012. A particularly preferred dispersing agent is PVP. In the coating agent, the dispersing agent ensures that the coating agent is present as a particularly stable dispersion. Settling behaviour is improved, especially if water is used as the diluent. In addition, it was found that the viscosity of the coating agent can be adjusted via the amount of dispersing agent. Ultimately, a coating agent with a dispersing agent can be stored better and processed better. It has been shown that, with PVP, both a very low viscosity and a small particle size in laser diffraction can be achieved. With other dispersing agents, it was more difficult to adjust both parameters within an optimal range at the same time.

In the coatings and composite coatings (for example, bipolar flat elements) according to the invention, the thickness of the coating can be in the range from 5 to 500 μm, preferably in the range from 10 to 250 μm, for example in the range from 20 to 100 μm. This means that the overall resistance of the FC or RFB can be kept at low, and at the same time there is corrosion stability.

Surprisingly, it was found that deformation of a flat metal or graphite element of a bipolar flat element can often be completely prevented if the element is coated with the coating agent according to the invention. The coated flat metal or graphite element can be processed with an embossing tool to imprint a flow field into the coating itself without deforming the flat element itself. It can be assumed that this property is achieved by (almost) irreversible compression of the expanded graphite of the coating agent in the regions where the embossing tool is pushed down.

If the coating has a flow field, the thickness of the coating at the thinnest points of the coating, for example in the region of a channel of the flow field, can be in the range from 5 to 250 μm. At the thickest points of the coating, for example in the region between the channels or channel portions of the flow field, the coating is thicker and has a thickness in the range from 20 to 500 μm.

In coatings or composite coatings (for example, bipolar flat elements) according to the invention, the coating can be single-layer or multilayer. In a multilayer coating, one layer can differ from another layer adjacent to it in that the mass fraction of expanded graphite and/or the mass fraction of binder in one layer is different from that in the other layer. The mass fraction of binder is preferably higher in a layer closer to the substrate or to the primary surface of the flat metal element than in a layer of the same coating farther from the substrate or the primary surface of the metal element. In general, the mass fraction of expanded graphite is then higher in the layer farther from the substrate or from the primary surface of the flat metal element than in the layer of the same coating located closer to the substrate or the primary surface of the metal element. It is assumed that the layer applied closer to the substrate then produces a very good seal and corrosion resistance. The layer farther from the substrate or from the primary surface of the metal element has higher electrical conductivity due to its higher content of expanded graphite. In addition, the layer farther from the substrate or from the primary surface of the metal element is better able to mould a flow field because it has a higher proportion of compressible, expanded graphite.

Further subjects according to the invention are thus: A multilayer coating comprising a first and a second layer which abut each other, wherein both layers contain expanded graphite and a binder, wherein the mass fraction of binder in the first layer is higher than that in the second layer, and wherein the mass fraction of expanded graphite in the second layer is higher than in the first layer. A composite coating comprising the multilayer coating on an electrically conductive substrate. A bipolar flat element comprising the multilayer coating on at least one of the two primary surfaces (preferably on both primary surfaces) of a flat metal element.

At least the second layer (or the layer further away from the substrate or from the primary surface of the metal element) can be obtained with the coating agent according to the invention. The first layer (or the layer closer to the substrate or the primary surface of the metal element) can also be obtained by means of a coating agent according to the invention. It must be ensured that the Q_{B} of the coating agent used to make the second layer (or the layer further from the substrate or the primary surface of the metal element) is higher than the Q_{B} of the coating agent used to make the first layer (or the layer closer to the substrate or to the primary surface of the metal element). Alternatively, a coating agent not according to the invention can also be used as the coating agent used for the production of the first layer (or the layer closer to the substrate or to the primary surface of the metal element)—for example, a coating agent which differs from the coating agents according to the invention only in the ratio Q_{B}.

The invention also relates to the use of a coating agent according to the invention for corrosion protection of a primary surface (preferably both primary surfaces) of a flat metal element contained in a bipolar flat element.

The invention also relates to the use of a coating agent according to the invention to protect a primary surface of a flat graphite element contained in a bipolar flat element from mechanical damage to the graphite element by media which come into contact with the bipolar flat element in an FC or RFB.

The coating agent of the present invention can also be used as an electrically conductive ink or an electrically conductive liquid.

The invention also relates to a method for producing a coating agent according to the invention or for producing a premix for producing a coating agent according to the invention, wherein expanded graphite in the form of particles and a dispersing agent, for example polyvinylpyrrolidone, is added to a diluent. This method is preferably a method for producing a coating agent according to the invention, wherein expanded graphite in the form of particles, a dispersing agent, for example polyvinylpyrrolidone, and a binder are added to the diluent. What is described herein with regard to individual features of coating agents, coatings, composite coatings and bipolar flat elements also applies to features of methods according to the invention.

The invention also relates to a premix, for example a dry premix, for producing a coating agent according to the invention, wherein the premix contains expanded graphite in the form of particles, and a dispersing agent, for example polyvinylpyrrolidone. A fully usable coating agent can be provided therefrom, in a particularly simple manner, proceeding from a particularly storable premix—for example, by adding a diluent and a binder and then subjecting this to a dispersion process. The binder can be at least partially dissolved in the diluent. Inks and lubricants can also be added into the premix.

### EXAMPLES

### Production of a Water-Based Graphite Dispersion:

To produce a water-based graphite dispersion, 1.5 g of the dispersing agent polyvinylpyrrolidone (PVP) and 0.75 g of benzoic acid were dissolved in 1.4 L of the diluent, water. 232.5 g of expanded graphite were added to the solution and dispersed therein by means of ultrasound. The total energy input was about 4.5 kWh.

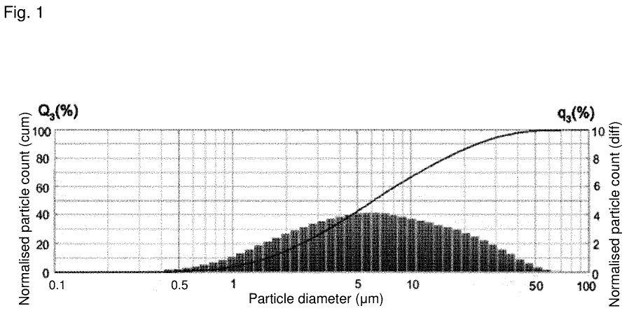

The particle size distribution of the water-based graphite dispersion was measured. The distribution is shown in FIG. 1.

### Production of a Premix According to the Invention:

The water-based graphite dispersion was dried at 100° C. for 24 h. An easily (re) dispersible premix was obtained. This contained expanded graphite in the form of particles, and about 0.65 wt. % of the dispersing agent polyvinylpyrrolidone (PVP), and a small amount of benzoic acid.

Production of a coating agent according to the invention according to a method according to the invention:

A solution of polyvinylidene fluoride/hexafluoropropylene copolymer (PVDF/HFP) as a binder was produced in a diluent (acetone) (9 wt. % PVDF/HFP in acetone). The solution was added to the premix and the premix was redispersed in the solution by ultrasonic treatment for 15 minutes.

### Mass Fractions of the Coating Agent:

PVDF/HFP: 7.8%
Expanded graphite: 5.2%
PVP: 0.09% small amount of benzoic acid

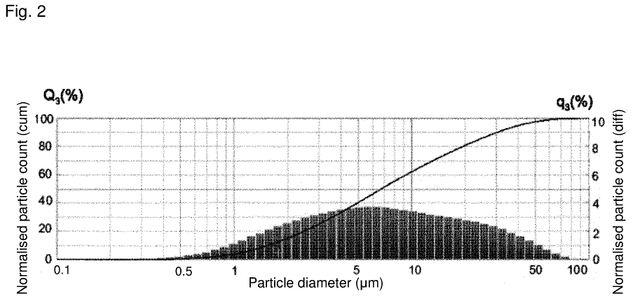

The particle size distribution of the coating agent was measured. This is shown in FIG. 2.

The following table shows the measured surface resistance with expanded graphite made from natural graphite and expanded graphite made from synthetic graphite. The values are the average of three measurements. For this purpose, the dispersions were prepared as follows:
a) A solution of polyvinylidene fluoride/hexafluoropropylene copolymer (PVDF/HFP), as a binder, was produced in a diluent (acetone) (9 wt. % PVDF/HFP in acetone). Ground graphite powder with a D50 of 5 μm was added to this solution and dispersed by ultrasonic treatment for 15 minutes.
b) For the dispersion according to the invention, 1.5 g of the dispersing agent polyvinylpyrrolidone (PVP) and 0.75 g of benzoic acid were dissolved in 1.4 L of the diluent water. 232.5 g of expanded graphite were added to the solution and dispersed therein by means of ultrasound. The total energy input was about 4.5 kWh. The dispersion was then dried in a circulating air oven. A solution of polyvinylidene fluoride/hexafluoropropylene copolymer (PVDF/HFP) as a binder was produced in a diluent (acetone) (9 wt. % PVDF/HFP in acetone). This solution was added to the dried graphite and redispersed for 15 minutes by means of ultrasonic treatment.

Both dispersions (a, b) were applied to a metal foil using a doctor blade and dried. Then the surface resistance was measured.

The surface resistance of the coating agent with expanded graphite made of natural graphite is significantly lower after compression at 10 MPa.

| | Surface resistance |
|---|---|
| a), uncompressed | 3.94 * 10⁻⁴ Ω cm² |
| a), compressed | 1.74 * 10⁻⁴ Ω cm² |
| b), uncompressed | 2.89 * 10⁻⁴ Ω cm² |
| b), compressed | 1.66 * 10⁻⁵ Ω cm² |

The electrical surface resistance is measured using the Hoiki RM2610 electrode resistance measuring system. A constant current is applied to the metal foil using the RM2610 and the potential distribution occurring on the surface is measured. The system models the surface of the coated metal foil, and the potential occurring at the surface is calculated. Using volume resistivity and interfacial resistivity as variables, the RM2610 repeatedly calculates the calculated potential until it matches the observed potential. Once the observed potential and calculated potential match, the resulting variables are reported. This method can be used to determine the interfacial resistivity, the volume resistivity, and the surface resistivity of a coating.

The particle size distributions shown in FIGS. 1 and 2 were determined using a Shimadzu SALD-7500 measuring apparatus with batch cell by laser diffraction, in accordance with ISO 13320-2009.

Steel sheets and foils were coated with the coating agent.

It was also possible to produce free-standing, thin graphite coatings. For this purpose, a separating coating was first applied to a metal foil. The coating agent was then applied to the metal foil and the resulting coating was then carefully peeled off.

### Production of a First Bipolar Flat Element:

A coating agent containing 5.5 wt. % expanded graphite, 8 wt. % PVDF/HFP in the diluent acetone was prepared as described above. A metal foil having a thickness of 0.1 mm was coated on both sides with the coating agent, to a thickness of about 200 μm. The coated metal foil was then embossed at 200° C. using an embossing tool. As a result, an embossed flow field could be created in the applied coating without deforming the metal foil. The depth of the channels was about 100 μm.

### Production of a Second Bipolar Flat Element:

A metal foil having a thickness of 0.1 mm was coated on both sides with the coating agent, to a thickness of about 100 μm. The coating agent used contained 5.5 wt. % of expanded graphite and 15 wt. % of PVDF/HFP in the diluent acetone. A second coating agent was then applied on both sides to a thickness of approx. 400 μm. The coating agent used contained 15 wt. % of expanded graphite and 8 wt. % of PVDF/HFP in the diluent acetone. The metal foil coated in multiple coatings in this way was then embossed at 200° C. with an embossing tool. As a result, an embossed flow field could be created in the applied, multilayer coating without deforming the metal foil. The depth of the channels was about 350 μm.

### Production of a Third Bipolar Flat Element:

A graphite foil having a density of 0.3 g/cm³ and a thickness of 2 mm was coated with a coating agent. The coating thickness was 100 μm on both sides. The coating agent contained 5.5 wt. % expanded graphite, 8 wt. % PVDF/HFP, in the diluent acetone. It was made as described above. The graphite foil coated in this way was then embossed at 200° C. using an embossing tool. This made it possible to produce a sealed, embossed pattern.

Further tests showed that the coating agents can be calendered. A coating agent according to the invention was applied to a metal foil with a doctor blade height of 300 μm. The coating was then compressed to a thickness of just 25 μm by calendering the composite coating. Metal and graphite foils can be coated on an industrial scale with the coating agents according to the invention in order to produce bipolar flat elements for fuel cells and redox flow batteries.

1-15. (canceled)

16. A coating agent for forming an electrically conductive coating on a substrate, wherein the coating agent comprises expanded graphite and a binder, and wherein the ratio Q_{B} of the mass of the expanded graphite comprised in the coating agent to the residual dry mass of the coating agent is at least 0.25.

17. The coating agent according to claim 16, wherein the expanded graphite is in the form of particles having a mean particle size d50 of less than 50 μm.

18. The coating agent according to claim 16, comprising a diluent, wherein at least part of the expanded graphite is dispersed in the diluent and at least part of the binder is dispersed or dissolved in the diluent.

19. The coating agent according to claim 16, comprising 1 to 35 wt. % of expanded graphite.

20. A coating comprising expanded graphite and a binder, wherein regions comprising the expanded graphite have an average length parallel to the surfaces of the coating which is at least twice as large as their average thickness.

21. A coating comprising expanded graphite and a binder, wherein the ratio Qₛ, calculated according to the following equation:
$${Q}_{S} = \frac{{m}_{SG}}{{m}_{SR}}$$
wherein
m_{SG} stands for the mass of the graphite comprised in the coating, and
M_{SR} stands for the mass of the non-volatile coating components comprised in the coating,
is at least 0.25.

22. A composite coating comprising a coating that comprises expanded graphite and a binder, on an electrically conductive substrate.

23. The coating agent according to claim 16, wherein the binder comprises thermoplastics and/or thermosets.

24. The coating agent according to claim 16, wherein the binder comprises a silicon compound which comprises a moiety R, wherein
R stands for —Si(OR¹)(OR²)(OR³), —O—Si(OR¹)(OR²)(R³), or —O—Si(OR¹)(OR²)(OR³),
wherein
R¹, R² and R³ are moieties each bonded via a carbon atom.

25. The coating agent according to claim 16, comprising a dispersing agent.

26. The coating according to claim 20, wherein the thickness of the coating is in the range from 5 to 500 μm.

27. A method for corrosion protection of a primary surface of a flat metal element that is comprised in a bipolar flat element, comprising applying the coating agent according to claim 16 to said primary surface.

28. A method for protecting a primary surface of a flat graphite element that is comprised in a bipolar flat element from mechanical damage to the graphite element by media which come into contact with the bipolar flat element in a FC or RFB, comprising applying the coating agent according to claim 16 to said primary surface.

29. A method for producing a coating agent according to claim 16 or a premix for producing the coating agent, wherein expanded graphite in the form of particles and a dispersing agent are added to a diluent.

30. A premix for the production of a coating agent according to claim 16, wherein the premix comprises expanded graphite in the form of particles and a dispersing agent.
